(19) United States
(12) Patent Application Publication
(10) Pub. No.: US 2016/0221887 A1
(43) Pub. Date: Aug. 4, 2016

(54) Method for Remodelling Surface of Granular Urea

(71) Applicant: SHANDONG MOITH ECOLOGICAL FERTILIZER CO., LTD., Shandong (CN)

(72) Inventor: Chenghu Zhong, Hefei (CN)

(73) Assignee: SHANDONG MOITH ECOLOGICAL FERTILIZER CO., LTD.

(21) Appl. No.: 15/095,005

(22) Filed: Apr. 8, 2016

(51) Int. Cl. C05C 9/00; C05C 9/02; C05G 3/00

(52) U.S. Cl. CPC C05C 9/005; C05G 3/0029; C05C 9/02

(57) ABSTRACT

A method for remodelling a surface of granular urea, comprising steps of: firstly, sending granular urea into a drum comprising a shoveling board and a heating air duct for rolling in clockwise or counterclockwise direction; then spraying a coating solution slowly and evenly on the surface of the granular urea; wherein moments friction between particles of the granular urea and the drum, particles and shoveling board, particles and particles drive bulges on the surface of the granular urea to be softened or dissolved into the coating solution by external force; drying particles of the granular urea, wherein part of the granular urea that is dissolved into the coating solution crystalizes and fills dents on the surface of granular urea, so the particles of the granular urea becomes smooth and rounded; and drying by air heater until the particles of the granular urea are hardened.

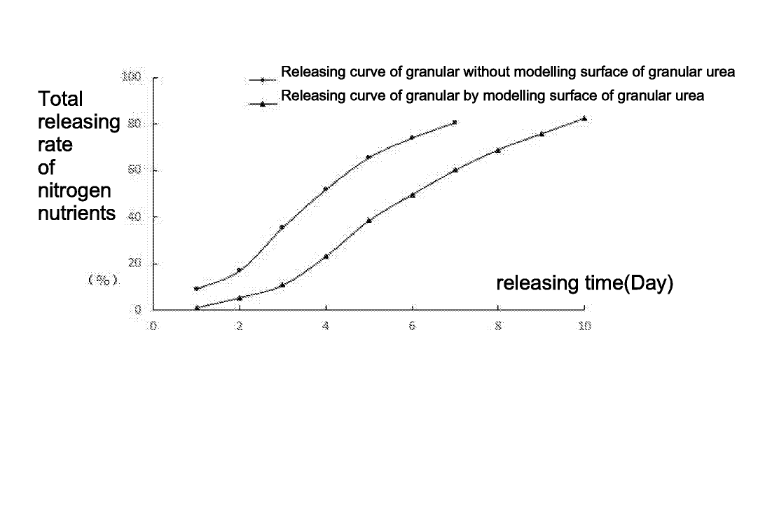

### BACKGROUND OF THE PRESENT INVENTION

1. Field of Invention

The present invention relates to a method for remodelling granular urea surface, which belongs to the field of urea manufacturing technology.

2. Description of Related Arts

Since chemical fertilizer is a source of nutrients for crop growth, the controlled release of nutrients in chemical fertilizer is very important. In recent years, new types of fertilizer have caused wide public concern. Compared with conventional fertilizer, slow/controlled release fertilizer is capable of automatically adjusting nutrient release based on the requirements of crops, i.e. the slow/controlled release fertilizer will neither release insufficiently and result in plant nutrient deficiency, nor release excessive nutrient and result in nutrient loss and waste, which significantly improves fertilizer utilization efficiency and reduces the amount of fertilizer used; it also has the advantages of reducing the frequency of fertilization, saving labor, reducing crop diseases and pests, and improving the quality of agricultural products etc. Thus, the slow/controlled release fertilizer has become one of the key fertilizers promoted by the Ministry of Agriculture.

Slow/controlled release fertilizer mainly comprises a core made of conventional fertilizer and a biodegradable organic coating agent covered on an external layer. The surface of the conventional factory manufactured granular urea has defects of rough and uneven surface, unevenly distributed particle size dark color and etc. These defects may result in incomplete coating, which will greatly increase nutrient release rate in the initial stage, thus repeated coating is required. As far as thin-film coating technology is concerned, this increases the cost of coating and reduces productivity. Thus, smooth and rounded surfaces of the granule urea particles are not only capable of improving productivity and reducing production costs, but also enhancing appearance quality of the granule urea and thus market competitiveness is improved.

A US patent application with a publication number of U.S. Pat. No. 6,039,781 discloses a fertilizer core surface modification technology, in which linseed oil is combined with clay/diatomite or other adhesives are mixed and applied to the surface of the fertilizer core to compensate for various surface defects. By means of this technology, coating defects are reduced and the initial dissolution rate of nutrients is decreased. An US patent application with a publication number of U.S. Pat. No. 6,663,686 also discloses a method of applying a coat of thin wax to the surface of fertilizer to improve nutrient digestion performance. Although these methods receives better effects than physical screening methods, the fertilizer surface pre-coating technology involves applying new materials to the surface of fertilizer, thus, firstly, the fertilizer surface pre-coating technology has relatively high demand for pre-coating materials; secondly, the thickness of coating and the adhesion of substrate are limited, and accordingly the improvement on substrate surface characters is limited.

A Chinese patent application with a publication number of CN101659583A discloses a method for post-processing granular fertilizer, in which granular fertilizer is placed in the drum and rolled, then urea and/or ammonium nitrate and adhesive coating liquid are applied to the surface of granular fertilizer, and dry to obtain products. Although no new material is added to the spraying and coating materials, adhesive can easily cause fertilizer to cake, besides, the large utilization amounts of coating material increases production costs.

### SUMMARY OF THE PRESENT INVENTION

An object of the present invention is to provide a method for remodelling a surface of granular urea. After being treated with the method provided by the present invention, the surface smoothness of granule urea is significantly improved and the surface hardness is increased, thus evenly coating is achieved and the rate of resin-coating is effectively decreased, so the cost of production is further reduced.

In order to solve the problems presented in the conventional arts, the method of the present invention comprises the following steps:

firstly, sending granular urea into a drum comprising a shoveling board and a heating air duct for rolling in a clockwise or counterclockwise direction;

then spraying a coating solution slowly and evenly on the surface of the granular urea; wherein moments friction between particles of the granular urea and the drum, particles and shoveling board, particles and particles drive bulges on the surface of the granular urea to be softened or dissolved into the coating solution by external force;

drying the particles of the granular urea, wherein a part of the granular urea that is dissolved into the coating solution crystalizes and fills dents on the surface of granular urea;

when the particles of the granular urea becomes smooth and rounded; drying by an air heater until the particles of the granular urea are hardened.

The coating solution is water, urea aqueous solution, formaldehyde aqueous solution, aqueous solution of urea and formaldehyde, urea formaldehyde aqueous solution, and aqueous solution of urea and ureaformaldehyde. A mass fraction of the urea in the coating solution is at a rang of 0-40%.

A mass fraction of formaldehyde in the coating solution is at a range of 0%-1%; a mass fraction of urea formaldehyde in the coating solution is at a range of 0-50%, a mass fraction of coating solution, measured on dry basis, accounts for 0.2%-2.0% of the granular urea.

In the present invention, in order for the recycling solution to be evenly sprayed on the surface of granular urea, the solution can be sprayed repeatedly in small amounts; a total amount of coating on the surface of granular urea, on dry basis, preferably accounts for 0.4%-1.5% of the mass of the granular urea, more preferably 0.5% -1.2%, and most preferably 0.7% -1.0%. A mass fraction of the urea in the coating solution is preferably at a range of 0-20%, more preferably 0-10%, and most preferably 0-5%. A concentration of formaldehyde in the coating solution is preferably 0.1%-0.5%, more preferably 0.2%-0.4%; a concentration of urea formaldehyde in the coating solution is preferably 1%-30%, more preferably 5%-10%.

The concentration of water, urea aqueous solution, formaldehyde aqueous solution, aqueous solution of urea and formaldehyde, urea formaldehyde aqueous solution, and aqueous solution of urea and ureaformaldehyde prepared in the present invention can guarantee that the solution is evenly distributed on the surface of granule urea after being dropped, so generally a concentration of the urea is at a range of 0-40%, preferably 0-20%, more preferably 0-10% and most preferably 0-5%; and the concentration of formaldehyde is 0%-1%, preferably 0.1%-0.5%, more preferably 0.2%-0.4%; the concentration of urea formaldehyde is 0%-50%, preferably 1%-30%, more preferably 5%-10%. Meanwhile, in order to ensure uniform motion of granule urea in the drum, ensure uniform friction force among shoveling board, drum wall and the particles, so as to obtain smooth and rounded surface, a chosen diameter of the drum is 0.5-10 m, preferably 1-8 m, more preferably 2-7 m; the feed height of granule urea is 0.1-1 m, preferably 0.3-0.7 m, most preferably 0.4-0.6 m. To ensure rapid surface prototyping of large granule urea, dry hot air is blown into the drum, and a temperature of the hot air is generally 70° C.-180° C., preferably 90° C.-150° C., more preferably 100° C.-130° C.

Specially speaking, technical solution of the present invention is as follows.

A method for remodelling a surface of granular urea, comprising steps of:

firstly, sending the granular urea into a drum comprising a shoveling board and a heating air duct for rolling in a clockwise or counterclockwise direction;

then spraying a coating solution slowly and evenly on the surface of the granular urea; wherein moments friction between particles of the granular urea and the drum, particles and shoveling board, particles and particles drives bulges on the surface of the granular urea to be softened or dissolved into the coating solution by external force;

drying the particles of the granular urea, wherein a part of the granular urea that is dissolved into the coating solution crystalizes and fills dents on the surface of granular urea, in such a manner that the particles of the granular urea becomes smooth, rounded;

terminating drying by an air heater until the particles of the granular urea are hardened.

Preferably, the coating solution is water, urea aqueous solution, formaldehyde aqueous solution, aqueous solution of urea and formaldehyde, urea formaldehyde aqueous solution, and aqueous solution of urea and ureaformaldehyde.

Preferably, a mass fraction of the coating solution, on dry basis, in the granular urea is at a range of 0.2%-2.0%, preferably 0.4%-1.5%, more preferably 0.5% -1.2%, most preferably 0.7% -1.0%.

Preferably, when the coating solution is urea aqueous solution, a mass fraction of the urea in the coating solution is 0-40%, preferably 0-20%, more preferably 0-10%, and most preferably 0-5%.

Preferably, when the coating solution is formaldehyde aqueous solution, a mass fraction of formaldehyde in the coating solution is at a range of 0%-1%, preferably 0.1%-0.5%, more preferably 0.2%-0.4%.

Preferably, when the coating solution is aqueous solution of urea and formaldehyde, a mass fraction of the formaldehyde in the coating solution is at a rang of 0-1%, preferably 0.1-0.5%, more preferably 0.2-0.4%; and a mass fraction of the urea in the coating solution is at a rang of 0-40%, preferably 0-20%, more preferably 0-10% and most preferably 0-5%.

Preferably, when the coating solution is urea formaldehyde aqueous solution, a mass fraction of urea formaldehyde in the coating solution is at a range of 0-50%, preferably 1-30%, more preferably 5-10%.

Preferably, when the coating solution is aqueous solution of urea and ureaformaldehyde, a mass fraction of the ureaformaldehyde in the coating solution is at a rang of 0-50%, preferably 1-30%, more preferably 5-10%; and a mass fraction of the urea in the coating solution is at a rang of 0-40%, preferably 0-20%, more preferably 0-10% and most preferably 0-5%.

Preferably, a diameter of the drum is at a range of 0.5-10 m, preferably 1-8 m, more preferably 2-7 m, most preferably 3-5 m.

Preferably, a feed height of granule urea is at a range of 0.1-1 m, preferably 0.3-0.7 m, more preferably 0.4-0.6 m.

Preferably, the method for remodelling the surface of the granular urea further comprises a step of: blowing dry hot air into the drum, wherein a temperature of hot air is at a range of 70° C.-180° C., preferably 90° C.-150° C., more preferably 100° C.-130° C.

Beneficial effects of the present invention are as follows.

1. The coating solution serves as a kind of nutrient for the substrate or is made of volatile substances, no other new substance is introduced, so performances of the granular urea itself is not changed.

2. Spraying water, urea aqueous solution, formaldehyde aqueous solution, aqueous solution of urea and formaldehyde, urea formaldehyde aqueous solution, and aqueous solution of urea and ureaformaldehyde on the surface of granular urea is capable of significantly improving hardness of granular urea, in such a manner that the granular urea is easy for coating and molding.

3. Amount of coating solution used is small, the processing equipment is simple, and thus the method of the present invention not only reduces production cost, but also improves quality of products.

These and other objectives, features, and advantages of the present invention will become apparent from the following detailed description, the accompanying drawings, and the appended claims.

### BRIEF DESCRIPTION OF THE DRAWINGS

The FIGURE is a sketch view of comparison of distribution curve between granular urea without surface remodelling and the granular urea processed by the method for remodelling a surface of the present invention.

### DETAILED DESCRIPTION OF THE PREFERRED EMBODIMENT

The present invention provides a method for remodelling a surface of granular urea, which is mainly used for coating the granular urea. The coating process comprises following steps of:

firstly, preheating the granule urea to a certain temperature, and then sending the granule urea to a rolling drum, wherein preferably a uniform shoveling board is provided in the drum to facilitate stirring granule urea, a beam is provided in the drum, in which a number of nozzles are distributed;

spraying the coating solution on the surface of the rolling granule urea, wherein with the rolling of granule urea particles, the solution is dispersed on the surface of granule urea particles, so as to form a thin layer of liquid membrane; with rapid evaporation of one or more members selected from the group consisting of water, urea aqueous solution, formaldehyde aqueous solution, aqueous solution of urea and formaldehyde, urea formaldehyde aqueous solution and aqueous solution of urea and ureaformaldehyde solidifies on the surface of granule urea, so as to reduce coarseness of the surface of granule urea particles; meanwhile, the surface of particles softens in moist environments, along with action of frictions among particles, smoothness and hardness of the particles of the granule urea are further improved; and

after the coating solution dries out, sending the coating solution for a second time via a second nozzle for a secondary coating which is identical to coating process for a first time; similarly repeating coating one by one via residual nozzles, until satisfying smooth particles are obtained; an interval between two sprays is at a range of 1-5 mins.

If the granule urea is used for coating, then the coating procedures can be designed as a pretreatment process for coating granule urea cores; the spraying temperature of granular fertilizer can be set to an identical temperature for coating, which not only saves energy but also controls the process in a easy way.

If the coating process is performed in the drum, the pre-spraying and coating can even be done in the some drum.

Next, the spraying process and effects thereof are illustrated combining with preferred embodiments as follows.

The following reagent and materials, unless otherwise specified, are obtained from commercial channels.

### Embodiment 1

Take 5.0 kg of granular urea with a particle diameter at a range of 2.00-4.75 mm provided by Jiangsu Double Chemical Co. Ltd. and put it in a drum with 4 uniform shoveling boards; adjust the speed so that the urea rolls at uniform motion in a clockwise direction. A certain amount of coating solution is added with a metering pump, and 100 g water is added every time; a nozzle atomizes water and sprays it on the surface of granule urea, so the surface of the granule urea moisturizes and softens, and then dries quickly with the help of a hot air dryer. 1-2 mins later, a second layer is sprayed on, followed by several more layers until the surface of granule urea is bright and smooth. When the granule urea is dry, discharge it. It can be seen that granular urea is not cohered or agglomerated, and the nutrient content of urea particles is not changed at all after remodelling. Through reconstruction, the roundness and brightness of granular urea is significantly improved.

### Embodiment 2

1. The preparation of coating solution: take 4 g formaldehyde and add it to a 1000 ml volumetric flask, a constant volume is obtained by adding distilled water. A mass concentration of formaldehyde solution prepared is 0.4%.

2. Take 5.0 kg granular urea with a particle diameter of 2.00-4.75 mm provided by Jiangsu Double Chemical Co. Ltd. and put it in a drum with 4 uniform shoveling boards; adjust the speed so that the urea rolls at uniform motion in a clockwise direction. A certain amount of coating solution is added to the drum with a metering pump, and 60 g solution is added every time; a nozzle atomizes water and sprays it on the surface of granule urea, so the surface of the granule urea moisturizes and softens, and then dries quickly with the help of a hot air dryer. 1-2 mins later, a second layer is sprayed on, followed by several more layers until the surface of granule urea is bright and smooth. The amount of formaldehyde aqueous solution sprayed is about 0.3%. When the granule urea is dry, discharge it. It can be seen that granular urea is not cohered or agglomerated, and the nutrient content of urea particles is not changed at all after remodelling. Through remodelling, the roundness and hardness of granular urea is significantly improved.

### Embodiment 3

1. The preparation of coating solution: take 50g urea formaldehyde and add it to a 500 ml volumetric flask, a constant volume is obtained by adding distilled water. A mass concentration of urea formaldehyde solution prepared is 10%.

2. Take 5.0kg of granular urea with a particle diameter at a range of 2.00-4.75 mm provided by Jiangsu Double Chemical Co. Ltd. and put it in a drum with 4 uniform shoveling boards; adjust the speed so that the urea rolls at uniform motion in a clockwise direction. A certain amount of coating solution is added with a metering pump, and 50 g solution is added every time; a nozzle atomizes water and sprays it on the surface of granule urea, so the surface of the granule urea moisturizes and softens, and then dries quickly with the help of a hot air dryer. 1-2 mins later, a second layer is sprayed on, followed by several more layers until the surface of granule urea is bright and smooth. The amount of urea formaldehyde aqueous solution sprayed is about 0.5%. When the granule urea is dry, discharge it. It can be seen that granular urea is not cohered or agglomerated, and the nutrient content of urea particles is not changed at all after remodelling. Through remodelling, the roundness and hardness of granular urea are significantly improved.

### Embodiment 4

### The Preparation of Coating Urea

Take 5.0 kg of the granular urea remodelled from Embodiment 3, heat to 50˜70° C. in a coater, then put pre-prepared organic polymer coating agent, which accounts for 1%˜2% of the total mass of core granule urea, into a coater; the organic polymer coating agent is mixed with the constantly moving granular urea, and quickly and evenly distributed to the surface of granular urea; after about 4˜6 mins, organic polymer coating agent solidifies into a dense, firm and smooth membrane. The above process is repeated 3˜5 times until coating is completed, then coated urea is obtained after cooling. One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for remodelling a surface of granular urea, comprising steps of:
firstly, sending the granular urea into a drum comprising a shoveling board and a heating air duct for rolling in a clockwise or counterclockwise direction;
then spraying a coating solution slowly and evenly on the surface of the granular urea; wherein moments friction between particles of the granular urea and the drum, particles and shoveling board, particles and particles drives bulges on the surface of the granular urea to be softened or dissolved into the coating solution by external force;
drying the particles of the granular urea, wherein a part of the granular urea that is dissolved into the coating solution crystalizes and fills dents on the surface of granular urea, in such a manner that the particles of the granular urea becomes smooth, rounded;
terminating drying by an air heater until the particles of the granular urea are hardened.

2. The method for remodelling the surface of the granular urea, as recited in claim 1, wherein the coating solution is water, urea aqueous solution, formaldehyde aqueous solution, aqueous solution of urea and formaldehyde, urea formaldehyde aqueous solution, and aqueous solution of urea and ureaformaldehyde.

3. The method for remodelling the surface of the granular urea, as recited in claim 1, wherein a mass fraction of the coating solution, on dry basis, in the granular urea is at a range of 0.2-2.0%.

4. The method for remodelling the surface of the granular urea, as recited in claim 2, wherein a mass fraction of the coating solution, on dry basis, in the granular urea is at a range of 0.7%-1.0%.

5. The method for remodelling the surface of the granular urea, as recited in claim 1, wherein when the coating solution is urea aqueous solution, a mass fraction of the urea in the coating solution is 0-40%.

6. The method for remodelling the surface of the granular urea, as recited in claim 4, wherein when the coating solution is urea aqueous solution, a mass fraction of the urea in the coating solution is 0-5%.

7. The method for remodelling the surface of the granular urea, as recited in claim 1, wherein when the coating solution is formaldehyde aqueous solution, a mass fraction of formaldehyde in the coating solution is at a range of 0-1%.

8. The method for remodelling the surface of the granular urea, as recited in claim 6, wherein when the coating solution is formaldehyde aqueous solution, a mass fraction of formaldehyde in the coating solution is at a range of 0.2-0.4%.

9. The method for remodelling the surface of the granular urea, as recited in claim 1, wherein when the coating solution is aqueous solution of urea and formaldehyde, a mass fraction of the formaldehyde in the coating solution is at a rang of 0-1%; and a mass fraction of the urea in the coating solution is at a rang of 0-40%.

10. The method for remodelling the surface of the granular urea, as recited in claim 8, wherein when the coating solution is aqueous solution of urea and formaldehyde, a mass fraction of the formaldehyde in the coating solution is at a rang of 0.2-0.4%; and a mass fraction of the urea in the coating solution is at a rang of 0-5%.

11. The method for remodelling the surface of the granular urea, as recited in claim 1, wherein when the coating solution is urea formaldehyde aqueous solution, a mass fraction of urea formaldehyde in the coating solution is at a range of 0-50%.

12. The method for remodelling the surface of the granular urea, as recited in claim 10, wherein when the coating solution is urea formaldehyde aqueous solution, a mass fraction of urea formaldehyde in the coating solution is at a range of 5-10%.

13. The method for remodelling the surface of the granular urea, as recited in claim 1, wherein when the coating solution is aqueous solution of urea and ureaformaldehyde, a mass fraction of the ureaformaldehyde in the coating solution is at a rang of 0-50%; and a mass fraction of the urea in the coating solution is at a rang of 0-40%.

14. The method for remodelling the surface of the granular urea, as recited in claim 12, wherein when the coating solution is aqueous solution of urea and ureaformaldehyde, a mass fraction of the ureaformaldehyde in the coating solution is at a rang of 0-40%; and a mass fraction of the urea in the coating solution is at a rang of 0-5%.

15. The method for remodelling the surface of the granular urea, as recited in claim 1, wherein a diameter of the drum is at a range of 0.5-10 m.

16. The method for remodelling the surface of the granular urea, as recited in claim 14, wherein a diameter of the drum is at a range of 3-5 m.

17. The method for remodelling the surface of the granular urea, as recited in claim 1, wherein a feed height of granule urea is at a range of 0.1-1 m.

18. The method for remodelling the surface of the granular urea, as recited in claim 16, wherein a feed height of granule urea is at a range of 0.4-0.6 m.

19. The method for remodelling the surface of the granular urea, as recited in claim 1, further comprising a step of: blowing dry hot air into the drum, wherein a temperature of hot air is at a range of 70° C.-180° C.

20. The method for remodelling the surface of the granular urea, as recited in claim 18, further comprising a step of: blowing dry hot air into the drum, wherein a temperature of hot air is at a range of 100° C.-130° C.
